(19) United States
(12) Patent Application Publication
(10) Pub. No.: US 2025/0237489 A1
(43) Pub. Date: Jul. 24, 2025

(54) Novel Stair Tread Measurer

(71) Applicant: Jiayi LAI, Qingyuan (CN)

(72) Inventor: Jiayi LAI, Qingyuan (CN)

(21) Appl. No.: 19/023,575

(22) Filed: Jan. 16, 2025

(30) Foreign Application Priority Data
Jan. 23, 2024 (CN) 202420169855.6
Jul. 23, 2024 (CN) 202421761948.4

(51) Int. Cl. G01B 3/08

(52) U.S. Cl. CPC G01B 3/08

(57) ABSTRACT

Disclosed is a novel stair tread measurer, including connecting bases, a sliding groove, a sliding bar, a connecting block, and edge rulers. One end of one of the connecting bases is connected to the sliding bar and the other end thereof is movably connected to one of the edge rulers. One end of the other one of the connecting bases is connected to the connecting base and the other end thereof is movably connected to the other one of the edge rulers. The sliding bar is slidably connected to one side of the sliding groove. The connecting block is connected to the other side of the sliding groove.

### TECHNICAL FIELD

The present disclosure relates to the technical field of measuring appliances, and in particular to a novel stair tread measurer.

### BACKGROUND

Stairs, as one of the common building designs, are widely used. There are strict requirements on the size of stair treads as functional and decorative panels.

At present, there are few measuring scales specifically used for measuring the size of stair treads. During measurement, a constructor cannot measure the size of the stair treads accurately, and measuring errors are easily accumulated, which results in that the stair treads are rather big or small. If the treads are rather big, the treads need to be secondarily cut on site, which increases the extra workload for construction, thereby affecting a construction progress. If the treads are rather small, a phenomenon that sealant lines are inconsistent in width is likely to happen, which affects decorative and ornamental effects.

Moreover, there is only one fixed point between an edge ruler and a sliding groove of an existing stair tread measurer, and the stair tread measurer is likely to loosen in a using process.

### SUMMARY

To overcome deficiencies in the prior art, the present disclosure aims to provide a novel stair tread measurer. By moving a sliding bar in a sliding groove, outer sides of edge rulers abut against both sides of a stair. After the edge rulers are positioned, a length and a width of a tread can be determined by an area enclosed by the outer sides of the edge rulers on both sides, the sliding groove, and an outer side of the sliding bar. The measurer is transferred to the tread to cut a size of the tread precisely. Moreover, through a magnetic limiting block, when the measurer is transferred to the tread, the measurer can be fixed to the tread more conveniently. Moreover, an arc-shaped groove is further formed in a connecting base, which is equivalent to additionally arranging a fixed point, so that the edge rulers are unlikely to loosen. The edge rulers also can change in terms of angle along the arc-shaped groove, so that a function of the present disclosure is enriched.

In order to achieve the above objective, the present disclosure adopts the following technical solution:

A novel stair tread measurer, including a connecting base, a sliding groove, a sliding bar, a connecting block, and an edge ruler, where one end of one of the connecting bases is connected to the sliding bar and the other end thereof is movably connected to one of the edge rulers; one end of the other one of the connecting bases is connected to the connecting block and the other end thereof is movably connected to the other one of the edge rulers; the sliding bar is slidably connected to one side of the sliding groove; and the connecting block is connected to the other side of the sliding groove.

It should be noted that a through hole is formed in one end of the sliding bar, and a first guide groove is formed at a bottom of the sliding groove; and the novel stair tread measurer further includes a fastening screw, the fastening screw penetrating through the through hole and stretching outside the first guide groove.

It should be noted that the novel stair tread measurer further includes a limiting block, where each of the connecting bases is provided with a pair of insertion connection grooves; and during use, one end of the limiting block is connected in the insertion connection grooves.

It should be noted that each of the connecting bases is further provided with a storage area, and in a normal state, the limiting block is placed in the storage area.

It should be noted that a magnetic part is arranged in the limiting block, and another magnetic part magnetically connected to the magnetic part is arranged on an outer surface of each of the insertion connection grooves.

It should be noted that a magnetic part is arranged in the storage area, and in a normal state, the limiting block is magnetically absorbed in the storage area.

It should be noted that each of the edge rulers is provided with a second guide groove, a via hole is formed in the other end of each of the connecting bases, and a fastening screw penetrates through the via hole and stretches outside the second guide groove.

It should be noted that the sliding groove further has different replaceable length dimensions.

Based on the above structure, the present disclosure further provides a variation of another technical solution:

A novel stair tread measurer, including a connecting base, a sliding groove, a sliding bar, and an edge ruler, where one end of the connecting base is connected to the sliding bar and the other end thereof is movably connected to the edge ruler, and the sliding bar is slidably connected in the sliding groove; and an arc-shaped groove is formed in the other end of the connecting base, and the edge ruler is configured to swing along the arc-shaped groove.

It should be noted that a through hole is formed in one end of the sliding bar, and a first guide groove is formed at a bottom of the sliding groove; and the novel stair tread measurer further includes a fastening screw, the fastening screw penetrating through the through hole and stretching outside the first guide groove.

It should be noted that the edge ruler is provided with a second guide groove, and when the connecting base is connected to the edge ruler, a fastening screw penetrates through the arc-shaped groove and stretches outside the second guide groove.

It should be noted that a via hole is formed in the other end of the connecting base, and the fastening screw penetrates through the via hole and stretches outside the second guide groove.

It should be noted that the novel stair tread measurer further includes a limiting block, where the connecting base is provided with an insertion connection groove; and during use, one end of the limiting block is connected in the insertion connection groove.

It should be noted that each of the connecting bases is further provided with a storage area, and in a normal state, the limiting block is placed in the storage area.

It should be noted that a magnetic part is arranged in the limiting block, and another magnetic part magnetically connected to the magnetic part is arranged on an outer surface of each of the insertion connection grooves.

It should be noted that a magnetic part is arranged in the storage area, and in a normal state, the limiting block is magnetically absorbed in the storage area.

Based on the above structure, the present disclosure further provides a variation of yet another technical solution:

A novel stair tread measurer, including a connecting base, a sliding groove, a sliding bar, and an edge ruler, where one end of the connecting base is connected to the sliding bar and the other end thereof is movably connected to the edge ruler, and the sliding bar is slidably connected in the sliding groove.

It should be noted that a through hole is formed in one end of the sliding bar, and a first guide groove is formed at a bottom of the sliding groove; and the novel stair tread measurer further includes a fastening screw, the fastening screw penetrating through the through hole and stretching outside the first guide groove.

It should be noted that the novel stair tread measurer further includes a limiting block, where the connecting base is provided with a pair of insertion connection grooves; during use, one end of the limiting block is connected in the insertion connection grooves; and a magnetic part is arranged in the limiting block, and another magnetic part magnetically connected to the magnetic part is arranged on an outer surface of each of the insertion connection grooves.

It should be noted that the connecting base is further provided with a storage area, and in a normal state, the limiting block is placed in the storage area; and a magnetic part is arranged in the storage area, and in a normal state, the limiting block is magnetically absorbed in the storage area.

It should be noted that each of the edge rulers is provided with a second guide groove, a via hole is formed in the other end of each of the connecting bases, and the fastening screw penetrates through the via hole and stretches outside the second guide groove.

It should be noted that the sliding groove further has different replaceable length dimensions.

The present disclosure has the following beneficial effects: the novel stair tread measurer is simple in structure and convenient to use; the length and the width of a tread can be accurately measured as the edge rulers, the sliding groove, and the sliding bar are matched, so that an error is avoided to a maximum extent; and through a magnetic limiting block, the limiting block is conveniently used. In addition, through an arc-shaped groove structure, in addition to effectively fix the edge rulers to prevent the edge rulers from loosening, the edge rulers swing along the arc-shaped groove, so that the edge rulers can be fixed at different angles.

### BRIEF DESCRIPTION OF FIGURES

FIG. 1 is a schematic structural diagram of the present disclosure;

FIG. 2 is a schematic structural diagram of a connecting block in FIG. 1;

FIG. 3 is a schematic structural diagram of a sliding groove in FIG. 1;

FIG. 4 is a schematic structural diagram of a sliding bar in FIG. 1;

FIG. 5 is a schematic structural diagram of a connecting base in FIG. 1;

FIG. 6 is a schematic structural diagram of a limiting block and a connecting base in the present disclosure;

FIG. 7 is a schematic diagram of a structure (partial) of another technical solution of the present disclosure;

FIG. 8 is a schematic structural diagram of the connecting base in FIG. 7;

FIG. 9 is a schematic structural diagram of a sliding bar in FIG. 7;

FIG. 10 is a schematic diagram of a sliding groove structure (partial) in FIG. 7;

FIG. 11 is a schematic diagram of an overall structure of another technical solution of the present disclosure; and

FIG. 12 is a schematic diagram of a structure of a technical solution of the present disclosure.

### DETAILED DESCRIPTION

The present disclosure will be further described below in conjunction with accompanying drawings. It should be noted that based on the premise of the technical solution, the present disclosure provides detailed embodiments and specific operating processes. However, the protection scope of the present disclosure is not limited to the embodiments.

A first solution of the present disclosure is as follows:

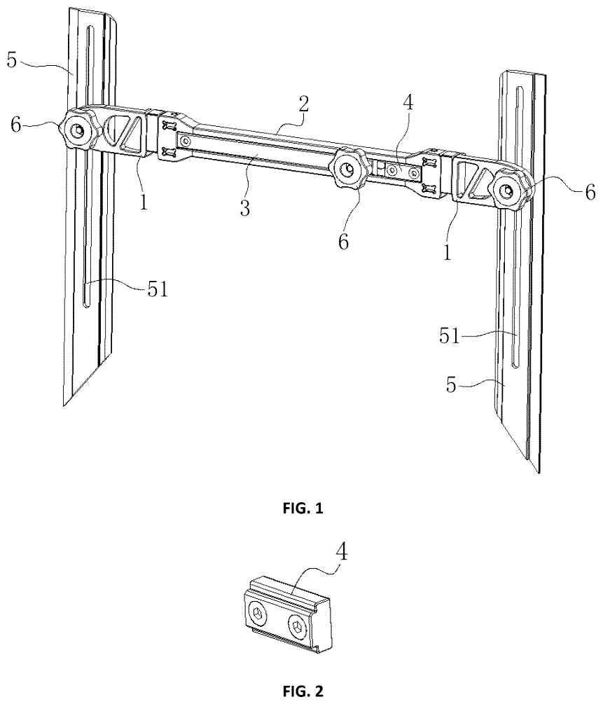

As shown in FIG. 1 and FIG. 2, the present disclosure provides a novel stair tread measurer, including a connecting base 1, a sliding groove 2, a sliding bar 3, a connecting block 4, and an edge ruler 5, where one end of one of the connecting bases 1 is connected to the sliding bar 3 and the other end thereof is movably connected to one of the edge rulers 5; one end of the other one of the connecting bases 1 is connected to the connecting block 4 and the other end thereof is movably connected to the other one of the edge rulers 5; the sliding bar 3 is slidably connected to one side of the sliding groove 2; and the connecting block 4 is connected to the other side of the sliding groove 2.

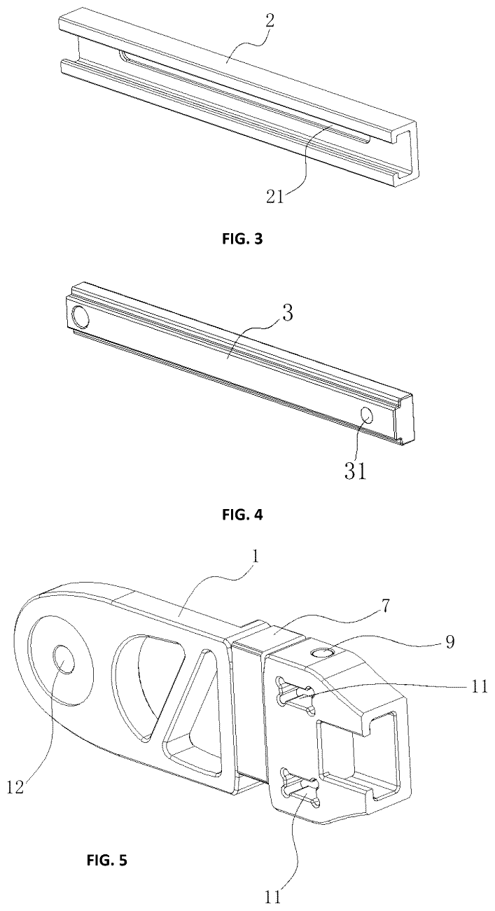

Further, as shown in FIG. 1, FIG. 3, and FIG. 4, a through hole 31 is formed in one end of the sliding bar 3 in the present disclosure, and a first guide groove 21 is formed at a bottom of the sliding groove 2; and the novel stair tread measurer further includes a fastening screw 6, and the fastening screw 6 penetrates through the through hole 31 and stretches outside the first guide groove 21.

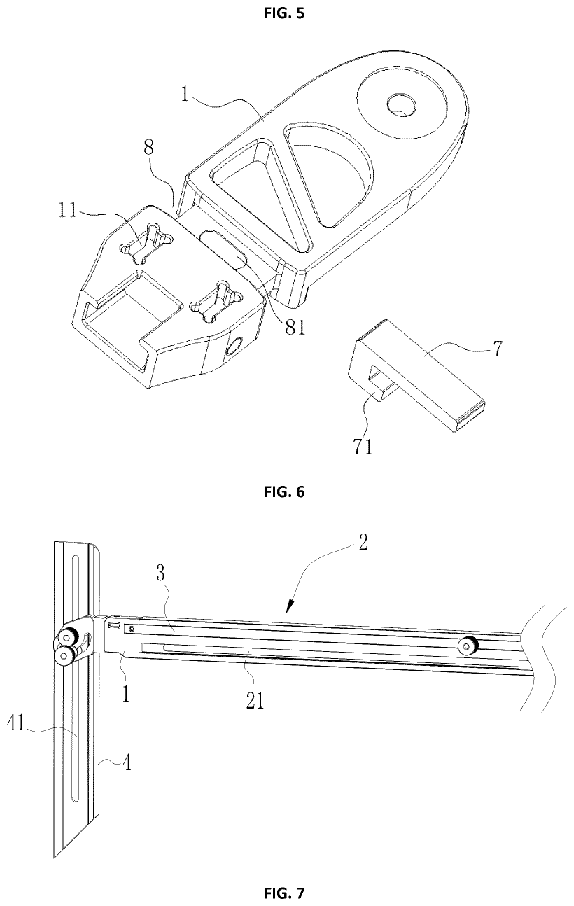

Further, as shown in FIG. 5 and FIG. 6, the novel stair tread measurer further includes a limiting block 7, where the connecting base 1 is provided with a pair of insertion connection grooves 11; and during use, one end 71 of the limiting block 7 is connected in the insertion connection grooves 11.

Further, as shown in FIG. 6, the connecting base 1 in the present disclosure is further provided with a storage area 8, and in a normal state, the limiting block 7 is placed in the storage area 8.

Further, as shown in FIG. 5, a magnetic part is arranged in the limiting block 7 in the present disclosure, and another magnetic part 9 magnetically connected to the magnetic part is arranged on an outer surface of each of the insertion connection grooves 11.

Further, as shown in FIG. 6, a magnetic part 81 is arranged in the storage area 8 in the present disclosure, and in a normal state, the limiting block is magnetically absorbed in the storage area.

Further, as shown in FIG. 1 and FIG. 5, the edge ruler 5 is provided with a second guide groove 51, a via hole 12 is formed in the other end of the connecting base 1, and the fastening screw 6 penetrates through the via hole 12 and stretches outside the second guide groove 51.

Further, the sliding groove in the present disclosure further has different replaceable length dimensions to fit different stair dimensions.

A second solution of the present disclosure is as follows:

As another variation of the technical solution of the present disclosure, an arc-shaped groove can be further formed in a connecting base, which is equivalent to additionally arranging a fixed point, so that edge rulers are unlikely to loosen. The edge rulers also can change in terms of angle along an arc-shaped groove.

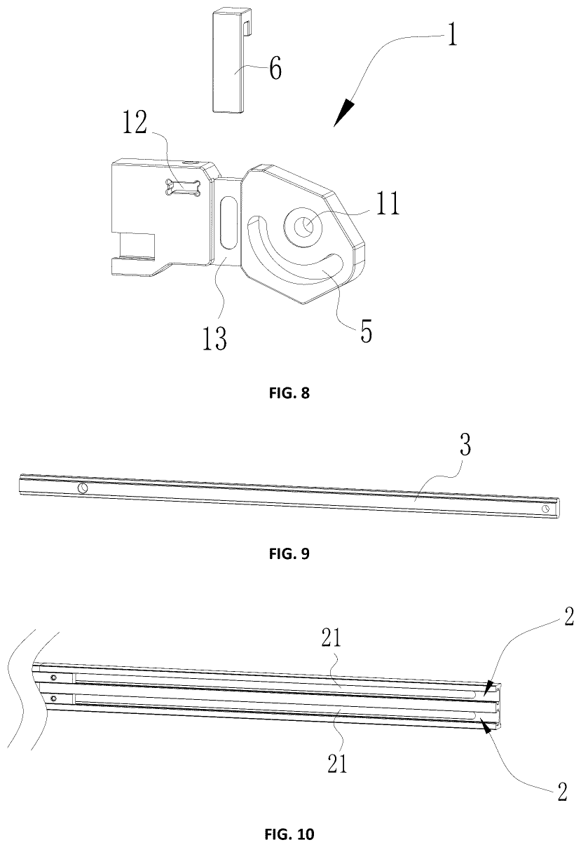

As shown in FIG. 7 and FIG. 8, the present disclosure provides a novel stair tread measurer, including a connecting base 1, a sliding groove 2, a sliding bar 3, and a type ruler 4, where one end of the connecting base 1 is connected to the sliding bar 3 and the other end thereof is movably connected to the type ruler 4, and the sliding bar 3 is slidably connected in the sliding groove 2; an arc-shaped groove 5 is formed in the other end of the connecting base 1, and the type ruler 4 is configured to swing along the arc-shaped groove 5.

Further, as shown in FIG. 7 and FIG. 9, a through hole is formed in one end of the sliding bar 3 in the present disclosure, and a first guide groove 21 is formed at a bottom of the sliding groove 2; and the novel stair tread measurer further includes a fastening screw, and the fastening screw penetrates through the through hole and stretches outside the first guide groove 21.

Further, as shown in FIG. 7, the type ruler 4 in the present disclosure is provided with a second guide groove 41. When the connecting base 1 is connected to the type ruler 4, the fastening screw penetrates through the arc-shaped groove 5 and stretches outside the second guide groove 41.

Further, as shown in FIG. 8, a via hole 11 is further formed in the other end of the connecting base 1 in the present disclosure, and the fastening screw penetrates through the via hole and stretches outside the second guide groove.

Further, as shown in FIG. 8, the novel stair tread measurer provided by the present disclosure further includes a limiting block 6, where the connecting base 1 is provided with an insertion connection grooves 12; and during use, one end of the limiting block 6 is connected in the insertion connection groove 12.

Further, as shown in FIG. 8, the connecting base 1 in the present disclosure is further provided with a storage area 13, and in a normal state, the limiting block 6 is placed in the storage area 13.

Further, a magnetic part is arranged in the limiting block in the present disclosure, and another magnetic part magnetically connected to the magnetic part is arranged on an outer surface of the insertion connection groove.

Further, a magnetic part is arranged in the storage area in the present disclosure, and in a normal state, the limiting block is magnetically absorbed in the storage area.

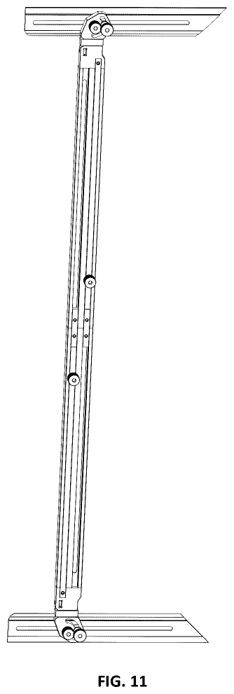

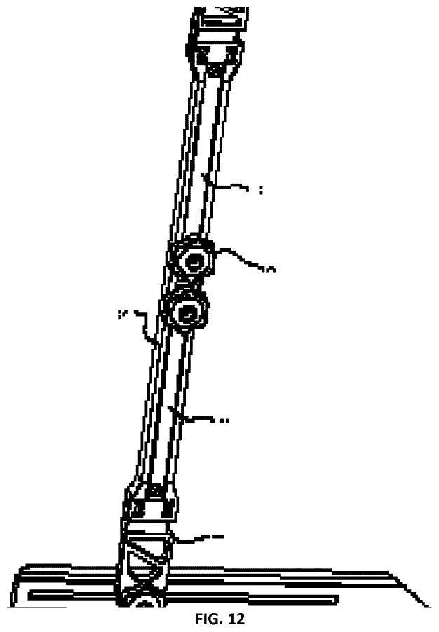

It should be pointed out that as a preferred technical solution, as shown in FIG. 10, in the present disclosure, upper and lower sliding grooves 2 can be respectively formed. When the sliding bars are slidably connected in the sliding grooves 2, one of the sliding bars can slide arbitrarily, and the sliding bars will not interfere with each other. Further, a number of the first guide grooves 21 should correspond to a number of the sliding grooves 2.

A third solution of the present disclosure is as follows:

As a variation of the first solution of the present disclosure, the connecting block structure can be removed, so that the connecting base is directly connected to the sliding bar, and the rest of structures is similar to the structures in the first solution, specifically as follows:

As shown in FIG. 12, the present disclosure provides a novel stair tread measurer, including a connecting base 1, a sliding groove 2, a sliding bar 3, and an edge ruler 4, where one end of the connecting base 1 is connected to the sliding bar 3, and the other end thereof is movably connected to the edge ruler 4, and the sliding bar 3 is slidably connected in the sliding groove 2.

Further, as shown in FIG. 12, a through hole is formed in one end of the sliding bar 3 in the present disclosure, and a first guide groove is formed at a bottom of the sliding groove 2; and the novel stair tread measurer further includes a fastening screw 5, and the fastening screw 5 penetrates through the through hole and stretches outside the first guide groove.

Further, the novel stair tread measurer provided by the present disclosure further includes a limiting block, where the connecting base is provided with a pair of insertion connection grooves; during use, one end of the limiting block is connected in the insertion connection grooves; and a magnetic part is arranged in the limiting block, and another magnetic part magnetically connected to the magnetic part is arranged on an outer surface of each of the insertion connection grooves.

Further, the connecting base in the present disclosure is further provided with a storage area, and in a normal state, the limiting block is placed in the storage area; and the magnetic part is arranged in the storage area, and in a normal state, the limiting block is magnetically absorbed in the storage area.

Further, the edge ruler in the present disclosure is provided with a second guide groove, a via hole is formed in the other end of the connecting base, and the fastening screw penetrates through the via hole and stretches outside the second guide groove.

Further, the sliding groove in the present disclosure further has different replaceable length dimensions.

### Embodiment 1

During use, by adjusting a position of a sliding bar in a sliding groove, a length of the present disclosure can fit different stairs till edge rulers on both sides abut against both sides of the stair. Further, by adjusting up-down distances of the edge rulers, a width of the stair can be determined. After the adjustment, the length and the width of the stair can be determined by an area enclosed by outer sides of the edge rulers on both sides, the sliding groove, and outer side of the sliding bar, and then a measurer is moved to a tread material. To fix the measurer on the tread material, a limiting block on a connecting base can be taken down and inserted into an insertion connection groove in the connecting base, and the limiting block abuts against one side of the stair tread, so as to prevent the measurer from displacing. Finally, the stair tread is cut according to a measured dimension to obtain a precise stair tread.

### Embodiment 2

During use, this embodiment is basically consistent with the Embodiment 1. By adjusting the position of the sliding bar in the sliding groove, the length of the present disclosure can fit different stairs till type rulers on both sides abut against both sides of the stair. Further, by adjusting the up-down distances of the type rulers, the width of the stair can be determined. After the adjustment, the length and the width of the stair can be determined by an area enclosed by outer sides of the type rulers on both sides, the sliding groove, and the outer side of the sliding bar, and then the measurer is moved to the tread material. To fix the measurer on the tread material, the limiting block on the connecting base can be taken down and inserted into the insertion connection groove in the connecting base, and the limiting block abuts against one side of the stair tread, so as to prevent the measurer from displacing. Finally, the stair tread is cut according to a measured dimension to obtain a precise stair tread.

In addition, since an arc-shaped groove is formed in the connecting base in the embodiment and besides having a function of adjusting an angle of the type ruler, the arc-shaped groove is equivalent to a fixed point importantly, which avoids a condition of inaccurate measurement due to loosening of the type ruler.

### Embodiment 3

During use, this embodiment is basically consistent with the Embodiment 1. By adjusting the position of the sliding bar in the sliding groove, the length of the present disclosure can fit different stairs till the edge rulers on both sides abut against both sides of the stair. Further, by adjusting the up-down distances of the edge rulers, the width of the stair can be determined. After the adjustment, the length and the width of the stair can be determined by an area enclosed by the outer sides of the edge rulers on both sides, the sliding groove, and the outer side of the sliding bar, and then the measurer is moved to the tread material. To fix the measurer on the tread material, the limiting block on the connecting base can be taken down and inserted into the insertion connection groove in the connecting base, and the limiting block abuts against one side of the stair tread, so as to prevent the measurer from displacing. Finally, the stair tread is cut according to a measured dimension to obtain a precise stair tread.

Persons skilled in the art can make various corresponding changes and transformations according to the above technical solution and concept, and all the changes and transformations shall fall within the protection scope of the claims of the present disclosure.

What is claimed is:

1. A novel stair tread measurer, comprising a connecting base, a sliding groove, a sliding bar, a connecting block, and an edge ruler, wherein one end of one of the connecting bases is connected to the sliding bar and the other end thereof is movably connected to one of the edge rulers; one end of the other one of the connecting bases is connected to the connecting block and the other end thereof is movably connected to the other one of the edge rulers; the sliding bar is slidably connected to one side of the sliding groove; and the connecting block is connected to the other side of the sliding groove.

2. The novel stair tread measurer according to claim 1, wherein a through hole is formed in one end of the sliding bar, and a first guide groove is formed at a bottom of the sliding groove; and the novel stair tread measurer further comprises a fastening screw, the fastening screw penetrating through the through hole and stretching outside the first guide groove.

3. The novel stair tread measurer according to claim 1, further comprising a limiting block, wherein each of the connecting bases is provided with a pair of insertion connection grooves; and during use, one end of the limiting block is connected in the insertion connection grooves.

4. The novel stair tread measurer according to claim 3, wherein each of the connecting bases is further provided with a storage area, and in a normal state, the limiting block is placed in the storage area.

5. The novel stair tread measurer according to claim 3, wherein a magnetic part is arranged in the limiting block, and another magnetic part magnetically connected to the magnetic part is arranged on an outer surface of each of the insertion connection grooves.

6. The novel stair tread measurer according to claim 4, wherein a magnetic part is arranged in the storage area, and in a normal state, the limiting block is magnetically absorbed in the storage area.

7. The novel stair tread measurer according to claim 1, wherein each of the edge rulers is provided with a second guide groove, a via hole is formed in the other end of each of the connecting bases, and a fastening screw penetrates through the via hole and stretches outside the second guide groove.

8. The novel stair tread measurer according to claim 1, wherein the sliding groove further has different replaceable length dimensions.

9. A novel stair tread measurer, comprising a connecting base, a sliding groove, a sliding bar, and an edge ruler, wherein one end of the connecting base is connected to the sliding bar and the other end thereof is movably connected to the edge ruler, and the sliding bar is slidably connected in the sliding groove; and an arc-shaped groove is formed in the other end of the connecting base, and the edge ruler is configured to swing along the arc-shaped groove.

10. The novel stair tread measurer according to claim 9, wherein a through hole is formed in one end of the sliding bar, and a first guide groove is formed at a bottom of the sliding groove; and the novel stair tread measurer further comprises a fastening screw, the fastening screw penetrating through the through hole and stretching outside the first guide groove.

11. The novel stair tread measurer according to claim 9, wherein the edge ruler is provided with a second guide groove, and when the connecting base is connected to the edge ruler, a fastening screw penetrates through the arc-shaped groove and stretches outside the second guide groove.

12. The novel stair tread measurer according to claim 11, wherein a via hole is formed in the other end of the connecting base, and the fastening screw penetrates through the via hole and stretches outside the second guide groove.

13. The novel stair tread measurer according to claim 9, further comprising a limiting block, wherein each of the connecting bases is provided with an insertion connection groove; and during use, one end of the limiting block is connected in the insertion connection groove.

14. The novel stair tread measurer according to claim 13, wherein each of the connecting bases is further provided with a storage area, and in a normal state, the limiting block is placed in the storage area.

15. The novel stair tread measurer according to claim 13, wherein a magnetic part is arranged in the limiting block, and another magnetic part magnetically connected to the magnetic part is arranged on an outer surface of each of the insertion connection grooves.

16. The novel stair tread measurer according to claim 15, wherein a magnetic part is arranged in the storage area, and in a normal state, the limiting block is magnetically absorbed in the storage area.

17. A novel stair tread measurer, comprising a connecting base, a sliding groove, a sliding bar, and an edge ruler, wherein one end of the connecting base is connected to the sliding bar and the other end thereof is movably connected to the edge ruler, and the sliding bar is slidably connected in the sliding groove.

18. The novel stair tread measurer according to claim 17, wherein a through hole is formed in one end of the sliding bar, and a first guide groove is formed at the bottom of the sliding groove; and the novel stair tread measurer further comprises a fastening screw, the fastening screw penetrating through the through hole and stretching outside the first guide groove.

19. The novel stair tread measurer according to claim 17, further comprising a limiting block, wherein the connecting base is provided with a pair of insertion connection grooves; during use, one end of the limiting block is connected in the insertion connection grooves; and a magnetic part is arranged in the limiting block, and another magnetic part magnetically connected to the magnetic part is arranged on an outer surface of each of the insertion connection grooves.

20. The novel stair tread measurer according to claim 19, wherein the connecting base is further provided with a storage area, and in a normal state, the limiting block is placed in the storage area; and a magnetic part is arranged in the storage area, and in a normal state, the limiting block is magnetically absorbed in the storage area.
